(19) United States
(12) Patent Application Publication
(10) Pub. No.: US 2026/0336540 A1
(43) Pub. Date: Oct. 29, 2026

(54) VEHICLE SECURITY

(71) Applicant: Ford Global Technologies, LLC, Dearborn, MI (US)

(72) Inventors: Bharath Mayanna Chandrashekhar, Novi, MI (US); Fouad Bounefissa, Oakville/Ontario (CA)

(73) Assignee: Ford Global Technologies, LLC, Dearborn, MI (US)

(21) Appl. No.: 19/186,930

(22) Filed: Apr. 23, 2025

(51) Int. Cl. B60R 16/023; B60R 25/30; G07C 5/00

(52) U.S. Cl. CPC B60R 16/0231; B60R 25/30; G07C 5/008

(57) ABSTRACT

In a vehicle, combined data is monitored to detect an anomaly in the combined data. The combined data includes data from outside of the vehicle and vehicle network data. The anomaly is transmitted from the vehicle to a cloud computer via a wide-area network in response to failing to identify the anomaly. Upon failing to identify the anomaly transmitted from the vehicle computer in the cloud computer, the data is input to a classifier. The cloud computer can transmit, to the vehicle computer, a vehicle operating command via the wide-area network upon the classifier outputting a threat determination.

### BACKGROUND

Connected vehicles, that is, vehicles that communicate via networks outside of the vehicle, such as so-called Software Defined Vehicles (SDV), can experience security challenges. As deployment of edge computing devices and the like in vehicles increases, and as vehicles become more integrated with wide-area digital networks, such security challenges are predicted to grow. For example, an unauthorized user or device may attempt to access vehicle data and/or the vehicle.

### BRIEF DESCRIPTION OF THE DRAWINGS

FIG. 1 is a diagram of an example vehicle system.

FIG. 2 is block diagram providing further details of the system of FIG. 1.

FIG. 3 is a flowchart illustrating an example process for vehicle security.

### DETAILED DESCRIPTION

The present disclosure includes techniques to operate a vehicle with enhanced security in communications and control. A vehicle computer can monitor one or more vehicle networks and also data received from a source or sources outside of the vehicle. For example, various controllers, sensors, or computers can provide data on a vehicle network. User devices such as a key fob, smartphones, etc., may communicate with a vehicle computer from outside the vehicle, typically wirelessly. Monitoring data on the vehicle network(s) and for sources outside of the vehicle the vehicle computer can detect an anomaly (i.e., a value not expected or defined for normal or typical operation of the vehicle) in the data. An anomaly can indicate a vehicle problem or concern such as a security threat, for example, that an unauthorized user is attempting to access the vehicle. Upon detecting the anomaly, the vehicle computer can attempt to identify the anomaly and, if the anomaly is identified, take responsive action. If the vehicle computer cannot identify the anomaly, it may be transmitted to a cloud computing system that may be able to identify the anomaly and/or responsive action to be taken.

A system comprises a vehicle computer that includes a first processor and a first memory, the first memory storing instructions executable by the first processor to monitor combined data that includes data from outside of a vehicle and vehicle network data to detect an anomaly in the combined data; and transmit the anomaly via a wide-area network in response to failing to identify the anomaly. The system further comprises a cloud computer that includes a second processor and a second memory, the second memory storing instructions executable by the second processor to upon failing to identify the anomaly transmitted from the vehicle computer, input the data to a classifier; and transmit a vehicle operating command via the wide-area network upon the classifier outputting a threat determination.

The vehicle computer or a second vehicle computer can include instructions to control a vehicle component in response to the vehicle operating command. The vehicle component can be a window, a door, a light, a speaker, steering, breaking, or a propulsion. The vehicle computer or a second vehicle computer can include instructions to control a vehicle component in response to identifying the anomaly. The vehicle computer can monitor a plurality of media to monitor the data from outside of the vehicle. The anomaly can be an unrecognized controller area network (CAN) signal or Ethernet Network message. The anomaly can be an unrecognized security key. The anomaly can be an out-of-range data value.

The cloud computer can store further instructions to, upon the classifier outputting an unknown anomaly determination, transmit the unknown anomaly determination to an incident manager. Upon the classifier outputting an unknown anomaly determination, the classifier can be updated to identify the unknown anomaly determination. Upon identifying the anomaly and the threat determination upon receiving the anomaly from the vehicle computer and without outputting the anomaly to the classifier, the cloud computer can transmit the vehicle operating command via the wide-area network.

A method, comprises monitoring combined data that includes data from outside of a vehicle and vehicle network data to detect an anomaly in the combined data; transmitting the anomaly from the vehicle to a cloud computer via a wide-area network in response to failing to identify the anomaly; upon failing to identify the anomaly transmitted from the vehicle in the cloud computer, inputting the data to a classifier; and transmitting, from the cloud computer to the vehicle, a vehicle operating command via the wide-area network upon the classifier outputting a threat determination.

The method can further comprise a vehicle computer controlling a vehicle component in response to the vehicle operating command. The vehicle component can be a window, a door, a light, a speaker, steering, breaking, or a propulsion. The method can further comprise controlling a vehicle component in response to identifying the anomaly. Monitoring the combined data can include monitoring a plurality of media to monitor the data from outside of the vehicle. The anomaly can be an unrecognized controller area network (CAN) signal or Ethernet Network message, an unrecognized security key, and/or an out-of-range data value.

The method can further comprise, upon the classifier outputting an unknown anomaly determination, transmitting the unknown anomaly determination to an incident manager. The method can further comprise, upon the classifier outputting an unknown anomaly determination, updating the classifier to identify the unknown anomaly determination. The method can further comprise, upon identifying the anomaly and the threat determination upon receiving the anomaly from the vehicle computer and without outputting the anomaly to the classifier, transmitting the vehicle operating command from the cloud computer via the wide-area network.

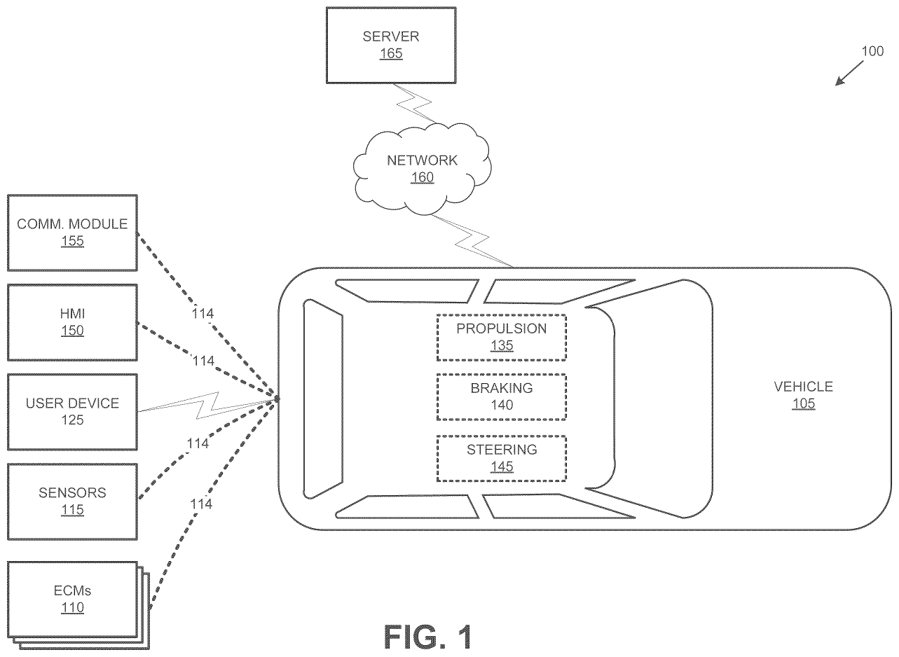

FIG. 1 illustrates an example system 100 for a vehicle 105. A computer or computers such as one or more electronic control modules (ECM s) 110 can be provided to control one or more vehicle operations including steering 145, propulsion 135 (i.e., controlling acceleration or speed), and/or braking 140. Accordingly, system 100 is shown comprising vehicle 105 which may include Driver Assistance System (DAS) features. A vehicle computer 110 (collectively represented in FIG. 1 as one or more vehicle 105 electronic control modules (ECM s) 110 or electronic control units) can be configured to operate the vehicle 105 independently of operation by an occupant with regard to certain features.

An ECM 110 may be provided to control operation of vehicle components such as an ignition or starter, windows, doors, seats, etc., in addition to controlling speed, steering, etc., as just mentioned. Accordingly, an ECM 110 can provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the ECM 110 could provide hand-free driving in combination with ACC such that the ECM 110 controls steering, braking and acceleration. In another example, the ECM 110 could provide A CC and require hands-on operation. The ECM 110 may be programmed to operate a propulsion 135, braking 140, steering 145, a device screen that displays a Human Machine Interface (HMI) 150, and/or other vehicle systems.

An ECM 110 could be configured for wireless communication with a user device 125 (e.g., a keyfob, smartphone, etc.) as well as being arranged for communications with other ECM s 110, sensors 115, etc., on a wired or wireless vehicle network 114. The vehicle network 114 can include, for example, a conventional vehicle communications bus such as a Controller Area Network (CAN) bus, a Local Interconnect Network (LIN) bus, etc., and/or other wired and/or wireless technologies, e.g., Bluetooth®, Wi-Fi®, Ethernet, UWB, etc. Via the network 114, the ECM 110 may transmit messages to various devices in the vehicle 105 and/or receive messages from the various devices, e.g., sensors 115, controllers and actuators (not shown), etc.

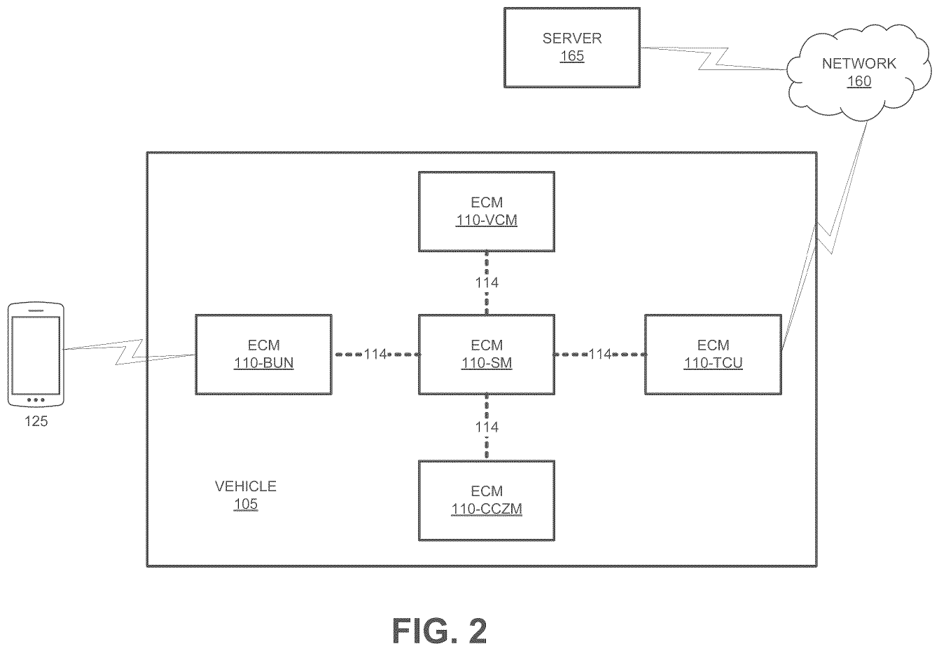

Alternatively or additionally, for example, in cases where the computer 110 actually comprises multiple devices (e.g., multiple ECM s 110), the vehicle network may be used for communications between computing devices such as ECM s 110. As described above and discussed further below (see FIG. 2), various ECM s 110 may be provided in a vehicle 105 dedicated to respective features or operations, such as security, telematics, control of body components such as windows and doors, etc.

An ECM 110 depicted herein could be a generic computer with a processor and memory, and/or may include a dedicated electronic circuit including an application specific integrated circuit (A SIC) that is manufactured for a particular operation, e.g., an A SIC for processing sensor data and/or communicating the sensor data. In another example, the ECM 110 may include a Field-Programmable Gate Array (FPGA) , which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an A SIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the ECM 110 (e.g., an ECM 110-TCU) may be programmed for communicating with a network and/or devices outside of the vehicle (not shown), which may include various wired and/or wireless networking technologies, e.g., cellular, Bluetooth®, Bluetooth® Low Energy (BLE), wired and/or wireless packet networks, etc.

A memory of a computer 110 can be of any suitable type, e.g., hard disk drives, solid state drives, servers, or any volatile or non-volatile media. The memory can store the collected data sent from the sensors 115. The memory can be a separate device from the ECM 110, and the ECM 110 can retrieve data stored in the memory via a network in the vehicle 105, e.g., over a CAN bus, a wireless network, etc. Alternatively or additionally, the memory can be part of the ECM 110, e.g., as a memory of the ECM 110.

Sensors 115 can include a variety of devices configured to acquire data from or about an environment of a vehicle 105. For example, various controllers or ECM s 110 in a vehicle 105 may operate as sensors 115 to provide data via the vehicle network or bus, e.g., data relating to vehicle speed, acceleration, location, subsystem and/or component status, etc. Further, other sensors 115 could include cameras, motion detectors, etc., e.g., sensors 115 may provide data for evaluating a status of a component, evaluating a slope of a roadway, etc. The sensors 115 could, without limitation, also include short range radar, long range radar, light detection and ranging (LIDAR), ultrasonic transducers, and the like. Cameras herein typically are optical cameras, e.g., in the visible spectrum, but could alternatively or additionally include other kinds of cameras, e.g., time-of-flight, infrared, etc.

Collected data can include a variety of data collected in a vehicle 105. Examples of collected data are provided above. Data are generally collected using one or more sensors 115, and may additionally include data calculated therefrom in the ECM 110. In general, collected data may include any data gathered by the sensors 115 and/or computed from such data.

The vehicle 105 can include a plurality of vehicle components. In this context, a vehicle component includes one or more physical parts adapted to perform a mechanical function or operation-such as moving the vehicle 105, slowing or stopping the vehicle 105, steering the vehicle 105, defining a vehicle 105 cabin (e.g., a door or window is a component), securing a vehicle cabin (e.g., a door lock or latch), etc. Non-limiting examples of components include a propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices, e.g., electronic control units (ECMs) or the like and/or computing devices such as described above with respect to the ECM 110, and that likewise communicate via a vehicle network.

The HMI 150 typically includes one or more of a display, a touchscreen display, a microphone, a speaker, etc. The user can provide input to devices such as ECM 110 via the HMI 150. The HMI 150 can communicate with the ECM 110 via the vehicle network, e.g., the HMI 150 can send a message including the user input provided via a touchscreen, microphone, a camera that captures a gesture, etc., to an ECM 110, and/or can display output, e.g., via a screen, speaker, etc.

As shown in FIG. 2, an ECM (or communications module) 110-TCU (sometimes referred to as a telematics control unit) may provide a vehicle-to-vehicle communication module or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 165 (typically via direct radio frequency communications)). The communications module ECM 110-TCU could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the ECM 110-TCU include cellular, Bluetooth, IEEE 802.11, dedicated short range communications (DSRC), cellular V2X (CV2X) , and/or wide-area networks (WAN), including the Internet, providing data communication services. The label “V2X” is used herein for communications that may be vehicle-to-vehicle (V2V) and/or vehicle-to-infrastructure (V2I), and that may be provided by communication module 110-TCU according to any suitable short-range communications mechanism (e.g., DSRC, cellular, or the like).

The network 160 represents one or more mechanisms by which a vehicle computer 110 may communicate with remote computing devices (e.g., the remote server computer 165, another vehicle computer, the infrastructure element 140, etc.). Accordingly, the network 160 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). The network 160 is generally called a “wide-area network” because it facilitates communications between devices that are geographically remote from one another. Components or subsets of the wide-area network may include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide-area networks (WAN), including the Internet.

FIG. 2 is a block diagram of elements of the system 100, including various ECM s 110 that can be included in a vehicle 105. These include an ECM 110-BUN that can wirelessly communicate with a user device 125, such as via Bluetooth, ultra-wideband (UWB), and or near field communications (NFC). Further, the ECM-110-BUN can communicate via the vehicle network 114 with devices including, for example, other ECM s 110, including an ECM 110-SM, an ECM 110-VCM, an ECM 110-CCZM, and the ECM 110-TCU.

The ECM 110-SM is a security module that can authenticate or authorize users and/or devices 125 seeking to access and/or control the vehicle 105. Authentication means confirming an identity of a user or device 125. Authorization means determining a permission for a user or device 125 to access one or more vehicle 105 features and/or components (e.g., to open doors, start a vehicle, move a vehicle, etc.). For example, a device 125 can be authenticated and then authorized to start and/or unlock a vehicle 105. Further, the ECM 110-SM can be configured detect an anomaly in data received via the vehicle network 114, such as from the ECM-110 BUN, an ECM 110-VCM, an ECM 110CCZM, and or some other ECM 110. The ECM 100-VCM is a vehicle control module or the like that can process input to start and/or move a vehicle, for example, when an authenticated and authorized device 125 provides input to start a vehicle. The ECM 110-CCZM, sometimes referred to as a zonal control module or a body control module, can process input to actuate vehicle 105 body components and/or other components, such as doors, windows, etc.

FIG. 2 accordingly depicts elements of a system wherein a vehicle computer such as ECM 110-SM and/or other ECM s 110 monitor combined data that includes data from outside of a vehicle 105 as well as data monitored on a vehicle network 114 to detect an anomaly in the combined data. The data from outside the vehicle could be detected via one or more media, such as Bluetooth, UWB, NFC, etc. An anomaly in the context of this disclosure means unrecognized (i.e., unexpected or undefined) data. Non-limiting example anomalies include the following. An anomaly could be an unrecognized datum or data on a network 114, such as an unrecognized controller area network (CAN) signal. Alternatively or additionally, an anomaly could be an unrecognized security key (e.g., received from a device 125 attempting to access the vehicle 105). Y et further alternatively or additionally, an anomaly could be an out-of-range data value. For example, a computer 110 could store an expected range for a data value acquired on a vehicle network 114 (e.g., a CAN signal or in an Ethernet Network message) such as a vehicle 105 speed; an anomaly could be detected when the speed was greater than an expected value and/or outside of an expected range (e.g., a vehicle speed of five-hundred kilometers per hour (K PH) could result in detection of an anomaly in an example implementation).

An anomaly can be identified or unidentified by a computer receiving data including the anomaly, such as ECM 110-SM, server 165, etc. An identified anomaly is one where the unexpected or undefined data matches a stored anomaly value (i.e., is equal to a stored anomaly value or is in a range of stored anomaly values); an unidentified anomaly is one that does not match a stored anomaly value. An anomaly could be identifiable by one computer but not by another. For example, a computer in a vehicle such as ECM 110-SM could store a smaller set of anomalies for identification than a could computer such as server 165. When a vehicle computer is unable to identify an anomaly, such as because the anomaly is not stored in the vehicle (such as in the ECM 110-SM), this situation may be referred to as the vehicle computer failing to identify the anomaly. When a vehicle computer cannot identify an anomaly, then the vehicle computer in response to failing to identify the anomaly, may transmit the anomaly via the network 160, whereby it can be received by server 165. Further, an anomaly detected by a vehicle computer can be logged in the vehicle (e.g., in a memory associated with WCH 110-SM) and can also be transmitted via the WAN 160 for receipt by server 165, although such transmission may not occur in real-time or near real-time as is typical upon failing to identify an anomaly.

A cloud computer such as one or more servers 165 (one server 165 being shown in the illustrated example) can receive an anomaly (e.g., in real-time or near real-time) from a computer in a vehicle 105. As explained above, server 165 can determine that the anomaly is identified or unidentified, including identifying an anomaly that was unidentified in a vehicle computer. Upon identifying an anomaly received from an unidentified by a computer in a vehicle 105, server 165 can in response provide a vehicle operating command to the vehicle 105. The server 165 can further transmit a vehicle operating command via the wide-area network based on output from a classifier. For example, upon failing to identify the anomaly transmitted from the vehicle computer, server 165 can input the anomaly data to a classifier, which may identify the anomaly, output the operating command and/or output a threat determination.

A threat determination herein means an identification of a threat or risk to a vehicle 105 and/or a user of a vehicle 105 based on identifying an anomaly. For example, a threat determination could specify that a vehicle is at risk of theft (e.g., because an identified anomaly indicates that a vehicle door or window has been breached, or that an identified anomaly indicates that the ECM 110-SM has detected one or more unexpected security keys and therefore it is possible that an unauthorized user is attempting to access the vehicle, or that an identified anomaly indicates that the vehicle 105 is at an unexpected location or is traveling at an unusual rate of speed), that a vehicle is not operating properly, etc.

The vehicle operating command is a command to control (e.g., actuate) a component of a vehicle 105. A vehicle computer such as the ECM 110-SM and/or some other vehicle computer such as a ECM 110-VCM and/or ECM 110-CCZM may include program instructions to control a vehicle component in response to the vehicle operating command. As explained above, a component can be a variety of parts or collections of parts (e.g., vehicle systems or subsystems), such as a door, a light, a speaker, HMI 150, steering 145, braking 140, or propulsion 135. A vehicle operating command can be associated with one or more threat determinations. For example, a computer 110, 165 could store a lookup table or the like specifying an operating command for execution in a vehicle 105 upon a threat determination. For example, one or more of a “lock propulsion,” “lock doors,” “activate lights,” “actuate HMI,” etc., operating command could be specified for various security breach threat indications, such as an unauthorized device 125 attempting to access the vehicle 105 (e.g., as indicated by one or more incorrect security keys detected by ECM 110-SM), an indication that a vehicle door is opened, etc. Actuating the HMI 150 in response to a threat determination could include specifying, e.g., via haptic, audio, or visual output, the threat determination, e.g., that there is a threat of a user trying to “hack” into vehicle network 114.

A vehicle computer such as ECM 110-SM may identify an anomaly upon detecting the anomaly. Further, the vehicle computer (e.g., ECM 110-AM) or a second vehicle computer (e.g., ECM 110-VCM and/or ECM 110-CCZM) can include instructions to control a vehicle component (e.g., to execute a vehicle operating command) in response to identifying the anomaly and/or in response to a threat determination and/or vehicle operating command from a cloud computing system (e.g., server 165).

As mentioned above, the server 165 may provide an anomaly (i.e., including a data value or values identified as the anomaly) to a classifier. A classifier in the context of this disclosure could include a machine learning program or the like that classifies, categorizes, or identifies input data. For example, a neural network or the like could be trained to output, based on input of data representing an anomaly, an identification of the anomaly or an output that the anomaly cannot be identified or recognized by the classifier. After being initially trained and implemented, the classifier could be updated on an ongoing basis. For example, on outputting that an anomaly is unidentified, the anomaly could be investigated and identified, e.g., by a human user, and then the classifier could be trained or updated to identify the anomaly represented by the input data.

Upon the classifier outputting an unknown anomaly determination (i.e., an indication that the classifier cannot identify the anomaly), the cloud computing system (e.g., including the server 165) can transmit the unknown anomaly determination to an incident manager. The incident manager includes a device or module that logs or stores incidents, that is, unknown anomaly determinations, for further investigation. As mentioned above, a human user could review unknown anomaly determinations and, an unknown (i.e., previously unidentified) anomaly can be identified then the classifier can be updated or trained to recognize or identify future instances of the anomaly, that is upon the classifier outputting an unknown anomaly determination, the classifier can be updated to identify the unknown anomaly determination.

As mentioned above, the server 165 may store identifications of anomalies not stored in a vehicle 105 by an ECM 110 or the like. For example, a vehicle 105 may be updated periodically with newly identified anomalies, and could experience an anomaly after the server 165 has been updated to identify the anomaly, but before the anomaly has been provided to the vehicle 105. Further, ECM 110 memory may be limited and therefore a vehicle 105 may store only anomalies determined (e.g., based on empirical analysis of reported anomalies for vehicles 105 of a particular type, e.g., size, propulsion type, make, and/or model, etc.) to have occurred in the type of vehicle 105 previously and/or to be most relevant for the vehicle 105 and/or to a location of the vehicle 105 (e.g., to a geographic region in which the vehicle 105 is operating. When the anomaly is determined to have occurred in the vehicle 105 and/or other vehicles 105 of a same or similar type, whether based on being already stored in the server 165 and/or based on output from the classifier, a vehicle 105 (e.g., a memory of an ECM 110) can be updated to identify the anomaly. Accordingly, upon identifying the anomaly and the threat determination upon receiving the anomaly from the vehicle computer the server 165 can transmit the threat determination and/or vehicle operating command via the wide-area network with or without outputting the anomaly to the classifier.

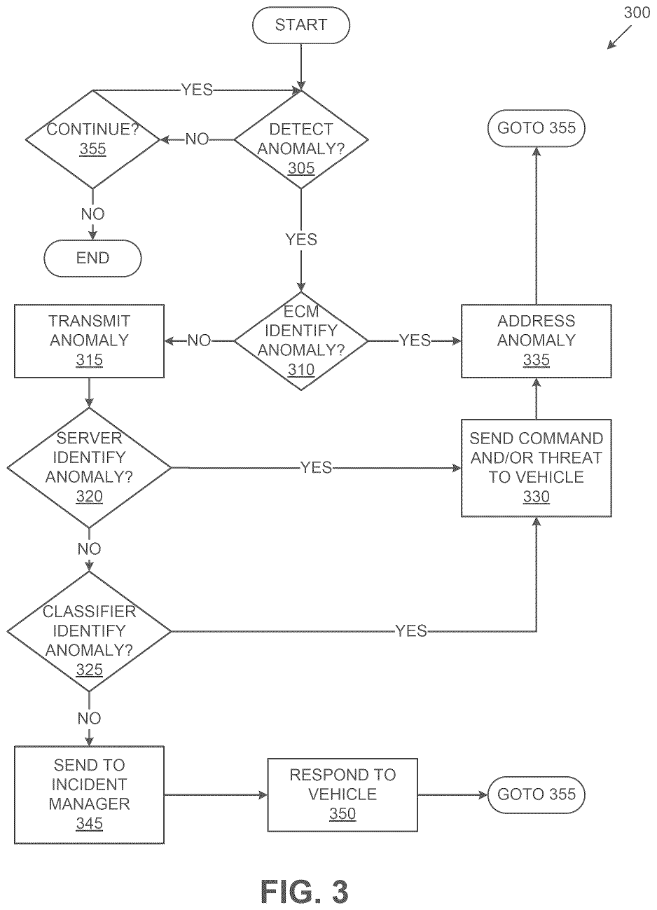

FIG. 3 is a flowchart illustrating an example process 300 for vehicle security. The various described process blocks could be executed in a different order then presented herein, and/or certain blocks could be omitted and/or other blocks could be added. Various blocks could be executed by a vehicle computer and/or cloud computer, represented in the exemplary process 300 by ECM 110-SM and server 165, respectively. The process 300 typically executes continuously when initiated after vehicle manufacture so long as sufficient power is available in the vehicle 105 even when a vehicle propulsion or ignition is in a “off”′ state, but alternatively or additionally the process 300 could be started by other mechanisms such as user input, by ECM SM detecting that the vehicle is in parked or off state, etc.

The process 300 may begin in a block 305, in which ECM 110-SM determines whether an anomaly is detected. If yes, the process 300 proceeds to a block 310. If not, the process 300 proceeds to a block 355.

In the block 310, the ECM 110-SM determines whether the detected anomaly can be identified, e.g., by consulting a lookup table or the like that lists anomalies in association with a type of data (e.g., a security key, a CAN signal, etc.) and a value or range of values expected or defined for the data. If yes, the process 300 proceeds to a block 335, but if the detected anomaly cannot be identified by the ECM 110-SM, then the process 300 proceeds to a block 315.

In the block 315, the ECM 110-SM transmits the detected anomaly to the server 165 via the WAN 160. For example, the ECM 110-SM could provide the anomaly to the ECM 110-TCU via the vehicle network 114, whereupon the ECM 110-TCU could cause the anomaly to be sent to the server 165 via the network 160.

In a block 320, following the block 315, the ECM 110-SM determines whether the detected anomaly can be identified, e.g., by consulting a lookup table or the like that lists anomalies in association with a type of data (e.g., a security key, a CAN signal, etc.) and a value or range of values expected or defined for the data. If the anomaly can be identified, then a block 330 is executed next. Otherwise, the process 300 proceeds to a block 325.

In the block 325, the server 165 inputs the anomaly to a classifier as described above. If the classifier identifies the anomaly, the process 300 proceeds to the block 330. Otherwise, the process 300 proceeds to a block 345.

In the block 330, which may follow one of the blocks 320, 325, the server 165, based on the identified anomaly, determines a threat determination and/or vehicle operating command, and transmits, via the WAN 160, the anomaly, threat determination, and/or vehicle operating command to the vehicle 105 (e.g., to be received by the ECM 110-ECU and provided to the ECM 110-SM.

In the block 335, which may follow one of the blocks 310, 330, the ECM 110-SM addresses and identified anomaly. For example, a vehicle operating command may have been determined in association with an identified anomaly in the block 310, or may have been determined by the server 165 and provided in the block 330. Further alternatively or additionally, the server 165 may have provided a threat determination from which ECM 110-SM could then determine a vehicle operating command. Following the block 335, the process 300 proceeds to the block 355.

In the block 345, which may follow the block 325, the unidentified anomaly is provided to an incident manager or the like, as described above. Further, as also described above, a newly identified anomaly once identified can be used to train or update the classifier, and/or a vehicle 125 (e.g., the ECM 110-SM) can be updated with a newly identified anomaly and/or an anomaly identified by the server 165 (as in the block 320) although not identified by the ECM 110-SM.

Following the block 345, the process 300proceeds to a block 350, or alternatively or additionally (although the process 300 is not so illustrated) the block 345 could be omitted and/or the block 350 could be executed prior to or contemporaneously with the block 345.

In the block 355, which may follow one of the blocks 305, 335, 350, it is determined whether the process 300 should continue. For example, a vehicle 105 could completely power down, the process 300 could be manually ended by a user, etc. In any case, if the process 300 is to continue, that the block 305 is executed next. Otherwise, the process 300 ends following the block 355.

Systems and methods described herein may be modified and/or omitted depending on the context, situation, and applicable laws, rules and regulations. Further, regardless actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby causing one or more actions and/or processes to occur, including one or more of the processes described herein. Such instructions and other data may be stored and transmitted using a variety of computer readable media. A file in the ECM 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM) , which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

“Based on” means based at least in part on unless explicitly stated otherwise. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising:
a vehicle computer that includes a first processor and a first memory, the first memory storing instructions executable by the first processor to:
monitor combined data that includes data from outside of a vehicle and vehicle network data for a detected anomaly in the combined data;
determine that the detected anomaly does not match an anomaly stored in the vehicle computer, and
transmit the anomaly via a wide-area network in response to determining that the detected anomaly does not match the anomaly stored in the vehicle computer; and
a cloud computer that includes a second processor and a second memory, the second memory storing instructions executable by the second processor to:
determine that the detected anomaly does not match an anomaly stored in the remote computer.
upon determining that the detected anomaly transmitted from the vehicle computer anomaly does not match the anomaly stored in the remote computer, input the detected anomaly to a classifier; and
transmit a vehicle operating command via the wide-area network upon the classifier outputting a threat determination.

2. The system of claim 1, wherein the vehicle computer or a second vehicle computer includes instructions to actuate a vehicle component in response to the vehicle operating command.

3. The system of claim 2, wherein the vehicle component is a window, a door, a light, a speaker, steering, breaking, or a propulsion.

4. The system of claim 1, wherein the vehicle computer or a second vehicle computer includes instructions to actuate a vehicle component in response to identifying the anomaly.

5. The system of claim 1, wherein the vehicle computer monitors a plurality of media to monitor the data from outside of the vehicle.

6. The system of claim 1, wherein the anomaly is an unrecognized controller area network (CAN) signal or Ethernet Network message.

7. The system of claim 1, wherein the anomaly is an unrecognized security key.

8. The system of claim 1, wherein the anomaly is an out-of-range data value.

9. The system of claim 1, the cloud computer storing further instructions to, upon the classifier outputting an unknown anomaly determination, transmit the unknown anomaly determination to an incident manager.

10. The system of claim 1, wherein, upon the classifier outputting an unknown anomaly determination, the classifier is updated to identify the unknown anomaly determination.

11. The system of claim 1, the cloud computer storing further instructions to, upon identifying the anomaly and the threat determination upon receiving the anomaly from the vehicle computer and without outputting the anomaly to the classifier, transmit the vehicle operating command via the wide-area network.

12. A method, comprising:
monitoring combined data that includes data from outside of a vehicle and vehicle network data for a detected anomaly in the combined data;
determining that the detected anomaly does not match an anomaly stored in the vehicle computer;
transmitting the anomaly from the vehicle to a cloud computer via a wide-area network in response to determining that the detected anomaly does not match the anomaly stored in the vehicle computer;
upon determining that the detected anomaly transmitted from the vehicle computer anomaly does not match the anomaly stored in the remote computer, inputting the detected anomaly to a classifier; and
transmitting, from the cloud computer to the vehicle, a vehicle operating command via the wide-area network upon the classifier outputting a threat determination.

13. The method of claim 12, further comprising a vehicle computer actuating a vehicle component in response to the vehicle operating command.

14. The method of claim 13, wherein the vehicle component is a window, a door, a light, a speaker, steering, breaking, or a propulsion.

15. The method of claim 12, further comprising actuating a vehicle component in response to identifying the anomaly.

16. The method of claim 12, wherein monitoring the combined data includes monitoring a plurality of media to monitor the data from outside of the vehicle.

17. The method of claim 12, wherein the anomaly is an unrecognized controller area network (CAN) signal or Ethernet Network message, an unrecognized security key, and/or an out-of-range data value.

18. The method of claim 12, further comprising, upon the classifier outputting an unknown anomaly determination, transmitting the unknown anomaly determination to an incident manager.

19. The method of claim 12, further comprising, upon the classifier outputting an unknown anomaly determination, updating the classifier to identify the unknown anomaly determination.

20. The method of claim 12, further comprising, upon identifying the anomaly and the threat determination upon receiving the anomaly from the vehicle computer and without outputting the anomaly to the classifier, transmitting the vehicle operating command from the cloud computer via the wide-area network.
